(19) United States
(12) Patent Application Publication
(10) Pub. No.: US 2013/0317867 A1
(43) Pub. Date: Nov. 28, 2013

(54) Method for Processing Insurance Claim Appeals

(71) Applicant: Vaughn Cecil, Provo, UT (US)

(72) Inventor: Vaughn Cecil, Provo, UT (US)

(21) Appl. No.: 13/901,410

(22) Filed: May 23, 2013

Related U.S. Application Data
(60) Provisional application No. 61/651,937, filed on May 25, 2012.

(51) Int. Cl. G06Q 40/08

(52) U.S. Cl. CPC G06Q 40/08
USPC 705/4

(57) ABSTRACT

A system and method for processing an appeal of an insurance claim is disclosed. The method involves a computer implemented process of receiving information about of a denied insurance claim, preparing the appeal, and generating a webpage that provides status information about the appeal to the parties to the appeal. The generated webpage can also provide an option to submit the appeal to an external appeals body when an internal appeals body has ruled unfavorably. Accordingly, the present invention can provide a single interface where an insured can submit appeals in a standard manner to facilitate the process of preparing and submitting appeals of denied insurance claims.

### CROSS-REFERENCE TO RELATED APPLICATIONS

This application claims the benefit of U.S. Provisional Patent Application No. 61/651,937 which was filed on May 25, 2012.

### BACKGROUND

1. Field of the Invention

This application relates generally to computer software. More specifically, this application relates to computer implemented methods for processing insurance coverage appeals forms. This application further relates to a computer-implemented method of processing insurance appeals for both an internal appeal proceeding and an external review proceeding.

2. Background

With an increased focus on improving modern health care insurance practices, recent policies have provided consumers with the right to appeal decisions of health care providers denying the consumer health care coverage. In such instances, consumers can make their case to one or both of an internal review board and an outside, independent arbiter. These reviewers can decide if the medical services are necessary and should be paid for by the health plan. It has been recognized that consumers have high degrees of success in overturning denials from insurance providers by using such methods. However, despite the effectiveness of such post-denial procedures, many consumers fail to satisfy the many formal requirements set forth to qualify for or succeed in these appeal procedures. As a result, many consumers fail to qualify to appeal their case or fail to succeed in their appeal proceeding. Other consumers do not pursue their valid cases because they simply do not know how to go about exercising their right to seek review of the claim denial.

### SUMMARY

The present invention has been developed in response to problems and needs in the art that have not yet been fully resolved by currently available insurance organizations. Thus, these systems and methods are developed to provide a computer implemented system and method for processing an appeal of an insurance claim. The computer implemented system and method can ensure that claimants and insurance administrators can file, track, and receive notifications about the status of the appeal. Moreover, the computer implemented system and method can notify the claimant about formal requirements, deadlines, and opportunities to prove his/her case.

Accordingly, in some aspects of the invention, a computer implemented method for processing an appeal of an insurance claim includes a server receiving insurance claim data of a denied insurance claim. Responsive to receiving insurance claim data, the server can prepare appeal data. The server can then generate one or more webpages that contain appeal status data relating to an appeal proceeding involving the denied insurance claim.

In another aspect, a system for processing insurance claim appeals includes a server having a data input module, an appeal preparation module, and a display module. The data input module can receive insurance claim data of an insurance claim. The appeal preparation module can prepare appeal data from the received insurance claim data. The display module can provide one or more webpages containing appeal status data relating to the internal appeal proceeding involving the insurance claim and instructions on the proper appeal procedures. The system can also include a database configured to store the insurance claim data, the appeal data, claim approval data relating to the insurance claim, claim denial data relating to the insurance claim, and/or the claimant evidence data relating to the insurance claim.

In yet another aspect, a computer implemented method for processing an appeal of an insurance claim is provided. The method includes a first server receiving insurance claim data of a insurance claim. The first server can then prepare first appeal data that relating to an internal appeal proceeding. The first server can also prepare second appeal data relating to an external appeal proceeding when the internal appeal proceeding denies the insurance claim, the second appeal data. The first server can generate a webpage containing appeal status data relating to the internal appeal proceeding involving the insurance claim and instructions on the proper appeal procedures. The first server can also store one or more of the claim data, the appeal data, claim decision data relating to the insurance claim, and claimant evidence data in a database relating to the insurance claim.

In one embodiment, the present invention is implemented as a method for providing a website that facilitates the submission of an appeal of a denied insurance claim. Fields for receiving insurance claim data of a denied insurance claim are displayed. The insurance claim data includes claimant information, provider information, administrator information, and claim information. Insurance claim data of a first denied insurance claim is received via the fields. Appeal data is generated from the insurance claim data. The appeal data is submitted to an appeals body to allow the appeals body to process the appeal data to determine whether the denied insurance claim was correctly denied. Decision data is then received from the appeals body. The decision data represents a determination made by the appeals body regarding the denied insurance claim. The decision data comprises one or more of: an approval of the denied insurance claim, a reversal of the denied insurance claim, or a modification to the denied insurance claim. The decision data is then displayed.

In some embodiments, when the appeals body is an internal appeals body, in conjunction with displaying the decision data, one or more fields for receiving input for submitting the appeal data to an external appeals body can also be displayed. This input can include input that specifies a particular external appeals body that should receive the appeal data to review the denied insurance claim. Also, status updates regarding the processing of the appeal data can be received and displayed.

These and other features and advantages of the present invention may be incorporated into certain embodiments of the invention and will become more fully apparent from the following description and appended claims, or may be learned by the practice of the invention as set forth hereinafter. The present invention does not require that all the advantageous features and all the advantages described herein be incorporated into every embodiment of the invention.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings.

FIG. 1 illustrates a representative system for implementing embodiments of the invention.

FIG. 2 illustrates a representative networked system configuration that may be used in association with embodiments of the present invention.

FIG. 3 illustrates a flowchart of a representative method for processing an appeal of an insurance claim.

FIG. 4 illustrates a flowchart of a representative method for transmitting or receiving insurance claim information.

FIG. 5 illustrates a representative claimant information page displayed in the embodiments of the method for processing an appeal of an insurance claim.

FIG. 6 illustrates a representative provider information page displayed in the implementations of the method for processing an appeal of an insurance claim.

FIG. 7 illustrates a representative administrator information page displayed in the implementations of the method for processing an appeal of an insurance claim.

FIG. 8 illustrates a representative claim information page displayed in the implementations of the method for processing an appeal of an insurance claim.

FIG. 9 illustrates a representative claim line item page displayed in the implementations of the method for processing an appeal of an insurance claim.

FIG. 10 illustrates a representative claim payment info page displayed in the implementations of the method for processing an appeal of an insurance claim.

FIG. 11 illustrates a representative internal appeal procedure page displayed in the implementations of the method for processing an appeal of an insurance claim.

FIG. 12 illustrates a representative internal appeal decision page displayed in the implementations of the method for processing an appeal of an insurance claim.

FIG. 13 illustrates another representative internal appeal decision page displayed in the implementations of the method for processing an appeal of an insurance claim.

FIG. 14 illustrates a representative external review organization page displayed in the implementations of the method for processing an appeal of an insurance claim.

FIG. 15 illustrates a representative external review procedure page displayed in the implementations of the method for processing an appeal of an insurance claim.

FIG. 16 illustrates a representative external review decision page displayed in the implementations of the method for processing an appeal of an insurance claim.

### DETAILED DESCRIPTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The following disclosure of the present invention may be grouped into subheadings. The utilization of the subheadings is for convenience of the reader only and is not to be construed as limiting in any sense.

The description may use perspective-based descriptions such as up/down, back/front, left/right and top/bottom. Such descriptions are merely used to facilitate the discussion and are not intended to restrict the application or embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB)”, that is, A is an optional element.

Various operations may be described as multiple discrete operations in turn, in a manner that may be helpful in understanding embodiments of the present invention; however, the order of description should not be construed to imply that these operations are order dependent.

The description may use the phrases “in an embodiment,” “in some embodiments,” “in some implementations,” or “in some instances,” which may each refer to one or more of the same or different embodiments. Furthermore, the terms “comprising,” “including,” “having,” and the like, as used with respect to embodiments of the present invention, are synonymous with the definition afforded the term “comprising.”

This application relates generally to computer software. More specifically, this application relates to methods for processing insurance coverage appeals forms. This application further relates to a computer implemented method of processing insurance appeals for both an internal appeal proceeding and an external review proceeding.

Accordingly, in some aspects of the invention, a computer implemented method for processing an appeal of an insurance claim includes a server receiving insurance claim data of a denied insurance claim. Responsive to receiving insurance claim data, the server can prepare appeal data. The server can then generate one or more webpages that contain appeal status data relating to an appeal proceeding involving the denied insurance claim.

In another aspect, a system for processing insurance claim appeals includes a server having a data input module, an appeal preparation module, and a display module. The data input module can receive insurance claim data of a insurance claim. The appeal preparation module can prepare appeal data from the received insurance claim data. The display module can provide one or more webpages containing appeal status data relating to the internal appeal proceeding involving the insurance claim and instructions on the proper appeal procedures. The system can also include a database configured to store the insurance claim data, the appeal data, claim approval data relating to the insurance claim, claim denial data relating to the insurance claim, and/or the claimant evidence data relating to the insurance claim.

In yet another aspect, a computer implemented method for processing an appeal of an insurance claim is provided. The method includes a first server receiving insurance claim data of a insurance claim. The first server can then prepare first appeal data that relating to an internal appeal proceeding. The first server can also prepare second appeal data relating to an external appeal proceeding when the internal appeal proceeding denies the insurance claim, the second appeal data. The first server can generate a webpage containing appeal status data relating to the internal appeal proceeding involving the insurance claim and instructions on the proper appeal procedures. The first server can also store one or more of the claim data, the appeal data, claim decision data relating to the insurance claim, and claimant evidence data in a database relating to the insurance claim.

In one embodiment, the present invention is implemented as a method for providing a website that facilitates the submission of an appeal of a denied insurance claim. Fields for receiving insurance claim data of a denied insurance claim are displayed. The insurance claim data includes claimant information, provider information, administrator information, and claim information. Insurance claim data of a first denied insurance claim is received via the fields. Appeal data is generated from the insurance claim data. The appeal data is submitted to an appeals body to allow the appeals body to process the appeal data to determine whether the denied insurance claim was correctly denied. Decision data is then received from the appeals body. The decision data represents a determination made by the appeals body regarding the denied insurance claim. The decision data comprises one or more of: an approval of the denied insurance claim, a reversal of the denied insurance claim, or a modification to the denied insurance claim. The decision data is then displayed.

In some embodiments, when the appeals body is an internal appeals body, in conjunction with displaying the decision data, one or more fields for receiving input for submitting the appeal data to an external appeals body can also be displayed. This input can include input that specifies a particular external appeals body that should receive the appeal data to review the denied insurance claim. Also, status updates regarding the processing of the appeal data can be received and displayed.

### Representative Operating Environment

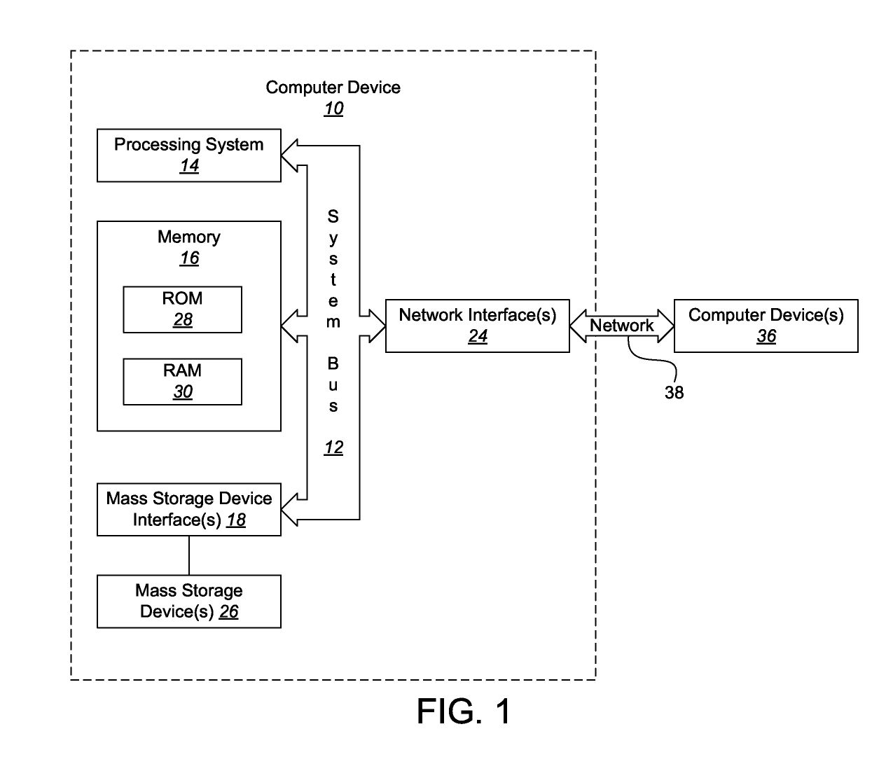

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, one or more server systems, other stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a server, personal computer, a workstation, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Those skilled in the art will appreciate that embodiments of the present invention embrace a variety of different system configurations. For example, in one embodiment the system configuration includes an output device (e.g., a multifunctional peripheral (MFP) or other printer/plotter, a copy machine, a facsimile machine, a monitor, etc.) that performs multi-colorant rendering. In another embodiment, the system configuration includes one or more client computer devices, optionally one or more server computer devices, and a connection or network communication that enables the exchange of communication to an output device, which is configured to perform multi-colorant rendering.

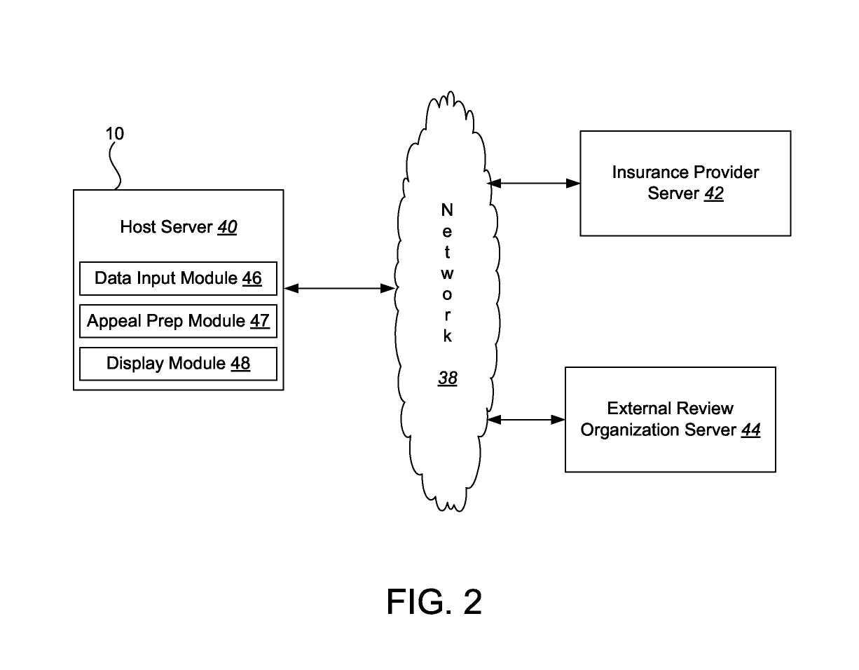

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device 10, illustrated as appeal server 40, which is connected to one or more other servers 42, 44 across network 38. The other servers can be an insurance provider server 42 and an external review organization server 44, as discussed below. While FIG. 2 illustrates an embodiment that includes an appeal server 40, two additional servers, alternative embodiments include more or fewer servers in the system. Other embodiments of the present invention include local, networked, or peer-to-peer environments where one or more computer devices may be connected to one or more local or remote peripheral devices. Moreover, embodiments in accordance with the present invention also embrace a wide area networked environments, such as the Internet.

Similarly, embodiments of the invention embrace cloud-based architectures where one or more computer functions are performed by remote computer systems and devices at the request of a local computer device. Thus, returning to FIG. 2, the appeal server 40 can provide software as a service (SaaS) to other networked computer devices having a limited set of hardware and/or software resources. Thus, computer devices 10 connected to the network 38 may be able to access the software resources provided across the network 38 by the appeals server 40. These computer devices 10 may access these software resources through an access program, such as a web browser, and the results of any computer functions or resources may be delivered through the access program to the user of the computer device. In such configurations, the computer device accessing the appeal server 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

### Representative Systems and Methods

According to some embodiments of the present invention, the invention may comprise systems and methods for processing an appeal of an insurance claim. As mentioned above, the method may be implemented using a computer, such as a server 40. The method and system can also be used to provide SaaS to individual consumers, health care organizations, health insurance organizations, or other institutions. The method can facilitate appeals and review (herein simply “appeals”) of health insurance claims. Particularly, the method can facilitate the appeals of denied claims for consumer health care coverage to one or both of an internal review board and an outside, independent arbiter. Internal appeals refer to review by one or more bodies within the insurance plan administrator or insurance provider. External appeals are reviews by neutral third party arbiters who have no economic stake in the outcome of the appeal. These reviewers can decide if the medical services are necessary and should be paid for by the health plan.

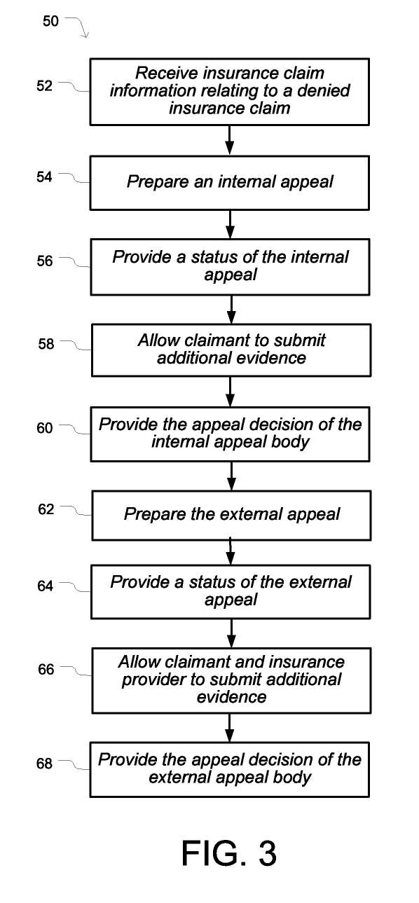

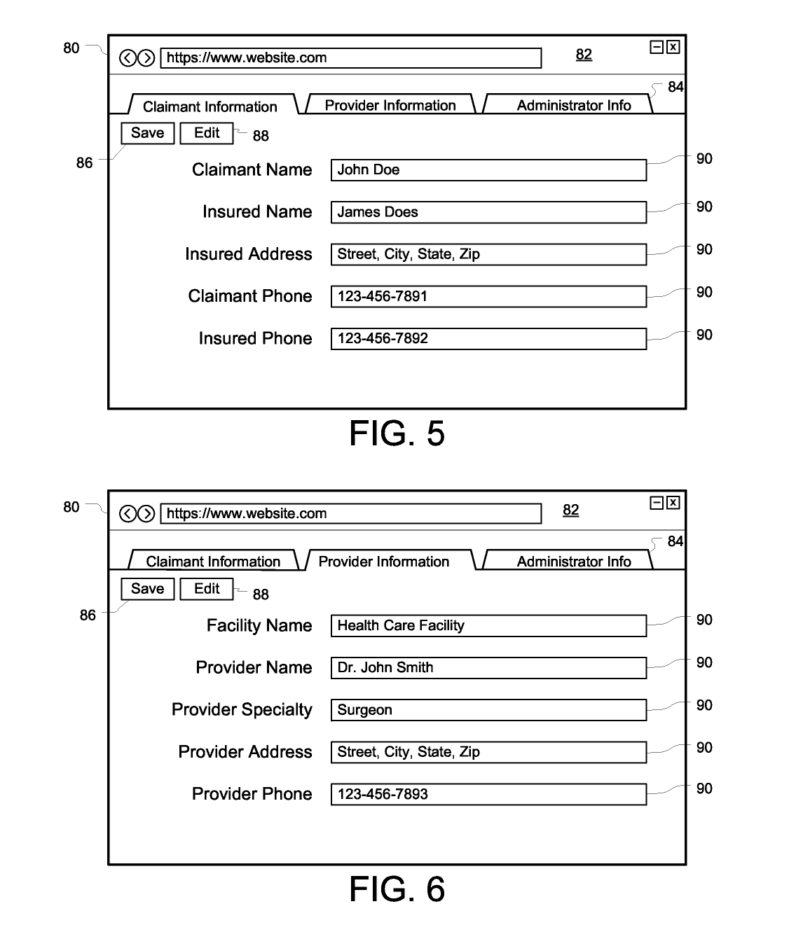

FIG. 3 illustrates a flowchart of embodiments of a general method 50 for processing appeals of insurance claims. FIGS. 5 through 16 then depict representative webpages, interfaces, or portals (herein simply webpages), capable of carrying out at least some of the general steps of the method 50. Reference will first be made to the method 50 illustrated in FIG. 3. Initially, in step 52 of the method 50, information relating to a denied insurance claim is received. This information can be referred to as insurance claim data, which can include information about the claimant, information about the insurer, information about the health provider (e.g., the doctor or surgeon), information about the claim, and information about the denial of the claim. This information can be received via a server 40 (shown in FIG. 2) across one or more webpages that, for example, offer software to consumers over the Internet or another network 38 (also shown in FIG. 2). In other instances, this information is received via a software application operating on a personal computer, network computer device, or other computer device.

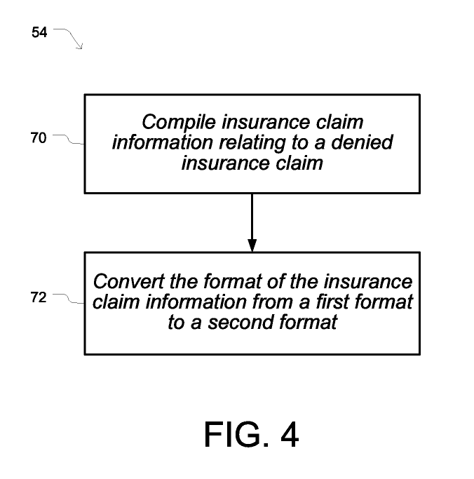

Turning briefly to FIG. 4, in some implementations, the step of receiving information relating to a denied insurance claim includes the step of converting the format of insurance claim data from a first format to a second format. This process can include the step of compiling insurance claim information relating to a denied insurance claim, in step 70. This information may be compiled on a computer device or server (shown as 42 in FIG. 2) of an insurance provider. In some instances, this information is already included in a patient/consumer profile, which can be transmitted in whole or in part to the appeals host server (shown as 40 in FIG. 2).

Some embodiments of the method 50 can include converting the format of the insurance claim data from a first format to a second format, as shown in step 72. In various embodiments, it may be advantageous to convert the format of the data of the insurance claim data before or after transmitting it to a system for processing insurance claim appeals. For example, the format change can be performed by a system of the insurance provider (e.g., server 42) prior to transmitting this information to the system that manages health care appeals. In another example, the format change can be performed by the host server 40 that manages the health care appeals. This conversion can be in a batch process or another suitable process.

For instance, many health care facilities maintain insurance claim data in an electronic data interchange (EDI) format, which is used to transfer electronic documents or data between computer systems and business organizations. While this standard may be useful, in some instances, converting to another standard such as an extensible markup language (XML) may be advantageous in transferring insurance claim data to an internet website server configured to display content using one or more web browsers. XML is a markup language for encoding documents in a format that is human-readable and machine readable, and is designed for simplicity, generality, and usability over the Internet. While the conversion from EDI to XML is described, it will be understood that the format of the insurance claim data can be converted from or to a variety of formats, including, for example, HTML, XML, XHTML, MHTML, TEX, GML, SGML, Scribe, MAF, ASP, ASPX, ADP, BML, JSP, SSI, CSV, XLS, XLSM, XLSX, PDF, DOC, DOCX, EGT, ODM, ODT, WPD, and other suitable known and future developed formats.

Turning again to FIG. 3, in step 54 of the method 50, the internal appeal is prepared. This step can include or consist of preparing appeal data. Preparing appeal data can include preparing and finalizing appeals documents, appeal arguments, and/or data needed for filing the appeal. For example, FIGS. 5 through 9 illustrate the collection of data that can be used in the method 50 to file an internal or external appeal. These Figures will be described in greater detail below. The nature of the appeal data can vary based on the appeal body handling the appeal. For instance, some appeal bodies can have distinctive appeal procedures, forms, and/or requirements. The present systems and methods can ensure that a consumer satisfies each of these requirements and facilitates the preparation of necessary documents. Because some appeals organizations may accept electronically filed appeals documents, in some instances, the method is further configured to electronically mail and/or submit appeals documents. This can include emailing, or electronically transmitting/filing the appeals data to the appeals organization or to a server of the appeals organization. Accordingly, in some configurations, the appeals server is configured to electronically transmit the appeals data to a server that manages the appeal docket of the appeals organization. Moreover, in addition to preparing the internal appeal, the method 50 can include the step (not shown) of filing the appeal. This can include manually (e.g., mailing or faxing) or electronically filing the appeal.

Continuing with FIG. 3, in step 56 of the method 50 after the internal appeal is filed, the system and method 50 can receive status updates from the appeals body and communicate the status updates to the consumer. These status updates can assist the consumer to track the progress of the appeal. Non-limiting examples of status updates include indicating that the appeal was filed, received, and/or assigned, notifying the consumer of a preliminary or final appeal decision, notifying the consumer of the need for additional information or evidence, or otherwise notifying the consumer of actions taken in the appeal proceeding. Embodiments of specific examples of status updates are shown in FIG. 12, which will be described below.

In step 58, in response to the status updates, the consumer can have the opportunity to submit additional evidence and the system can receive this evidence electronically from a computer device used by the consumer. The type of evidence that can be submitted will be dependent upon the type of status udpate. For example, a consumer can submit financial records, business records, medical records, or other such records. Beneficially, the method 50 can allow the consumer to submit this additional evidence via the same webpages or related webpages that are used to submit the insurance claim data. Alternatively, the method 50 can provide requests for addition data via email messages, traditional mail messages, fax messages, or other suitable message types.

In step 60, after the appeal body has decided the outcome of the internal appeal, the method 50 can provide the consumer with the appeal decision of the appeal body. Generally, the appeal decision is to deny the claim, approve of the claim, and/or pay the claim in part or full. In some embodiments, the method further provides one or more reasons for denying the appeal decision. Beneficially, the method 50 can provide the appeal decision via the same webpages or related webpages that are used in one or more of the previous steps.

Following an internal appeal decision, the consumer may have the right to seek external review of the internal appeal decision from a neutral arbiter or several neutral arbiters. These arbiters can review the decision of the internal appeal body or review the entire case de novo. Prior to and following recent changes in the health care insurance structures, several such third-party organizations have been established for handling such appeals. The consumer may thus select from one or more such neutral arbiters for handling the appeal. In some instances, a health care insurance organization may have preferred appeals organizations from which the consumer may select.

Thus, in steps 62 through 66, the method 50 provides similar steps to those it provided in handling the internal appeal in steps 42 through 60 when it handles the external appeal. A description of these steps will not be repeated. The method 50 may provide one or more webpages for providing these steps of the external appeal, as with the steps of the internal appeal. After the external appeal body has issued its decision, in step 68, the webpage can store information about the appeal(s) including the claim data, the decision of the claim on appeal, evidence submitted during the appeal, correspondence between the parties in the appeal, and other appeal data.

In some instances, an insurance plan may permit a consumer to forego the internal appeal and appeal directly to an external appeal organization. In such instance, the method 50 does not include steps 54 to 60, but skips from step 54 to step 62.

Reference will now be made to FIGS. 5 through 16, which illustrate a series of representative webpages 80, according to some embodiments, that depict some implementations of the method 50 illustrated in the flowchart of FIG. 3. As used herein, the term “webpage” refers to a document or information resource that is suitable for the World Wide Web and can be accessed through a web browser and displayed on a monitor or mobile device. Some embodiments of webpages 80 are in HTML or XHTML format or other available formats and may provide navigation to other webpages via links in the page. The webpage 80 may be retrieved from the appeals server 40 (shown in FIG. 2).

In some embodiments, all or portions of the webpage can only be accessed by authorized users. Thus, methods can be provided for performing user authentication and authorization. In one implementation, user authentication can be performed via logon passwords. For example, in some embodiments, a user can register using an assigned or self-declared password. In some embodiments, a user is required to pay a fee to become authorized with authorized login information. In other embodiments, any necessary fees are paid by the consumer's health care plan, which provides access to the webpage for conducting internal and external appeals.

Upon successful authentication, a user can be authorized to access information via the webpage. According to some embodiments, the system provides varying levels of access restrictions. Thus, the system can provide user access to various features and portions of the webpage based on the user's access authorization level or authorization type. Thus, in some embodiments, a user can pay to have or can be assigned a certain authorization level. For example, a claimant can have access to information available to claimants, but may not be privy to health provider, appeal body, or insurance provider information. Similarly, health providers, appeal bodies, and insurance providers can have respective access restrictions limiting the content which they can view via the webpage.

Turning to the illustrated webpage 80 of FIG. 5, in instances where the webpage operates on a web browser, the webpage 80 can be presented within the web browser. As such, the webpage may be presented with a web browser header 82 that can include an address block, and various web browser control icons. Non-limiting examples of web browsers include browsers having a graphical user interface, such as, Internet Explorer, Mozilla Firefox, Chrome and Opera, or text-based browsers, like Lynx or Links. In the body of the webpage 80, which is shown below the web browser header 82, the webpage 80 can display content to the user that enables the user to navigate within the webpage 80 and input, edit, and/or save data to the server (40) via the webpage 80. Accordingly, a save button 86 and an edit button 88 can be provided on the webpage 80. Additionally, the webpage can include prompts for the user to submit specific information into one or more text input blocks 90.

Generally, one or more webpages 80 can be provided by the server (40) to perform the method 50, or variations of the method 50, previously described, for processing an appeal of a denied insurance claim. Functionally and aesthetically, the webpages 80 can be designed in various ways. For simplicity, the webpages 80 shown in FIGS. 5 through 16 include one or more tabs 84 for navigating between related pages. In some instances, a webpage 80 includes only a few of the illustrated tabs. In other instances, a single webpage 80 can include multiple or all of the tabs 84 illustrated in these Figures. Tabs or individual webpages 80 can be divided up to include specific categories of information about a claim or appeal. Non-limiting examples of tabs include a claimant information tab, a provider information tab, and administrator information tab, a claim information tab, a claim line items tab, a claim payment information tab, an internal appeal procedure tab, an internal appeal decision tab, an external review organization tab, an external review procedure tab, and an external review decision tab. These representative tabs are illustrated in FIGS. 5 through 16 and described below.

Reference will first be made to the webpage 80 of FIG. 5, which illustrates a webpage configured to receive claimant information. As such, in some embodiments, the webpage 80 can present this information via a claimant information tab 84. Claimant information can be at least a part of the claim information or claim data that is collected by the system and used to prepare the appeal. As such, one or more webpages 80 can provide various text input blocks 90 for receiving claimant data. The webpage 80 can also provide various prompts that indicate the required data that is to be inserted into the various text input blocks 90. For instance, as shown, the webpage 80 can prompt a user to input the claimant name, the insured name, the insured party's address, and the claimant and insured parties' phone numbers. This claimant data can be received by the server 40 and used to identify the claimant and contact the claimant. Additionally or alternatively, the webpage 80 can prompt a user to input the claimant's or insured's email address, alternative phone numbers, and/or other identifying information or contact information. Examples of such claimant data is shown in the illustrated text input blocks.

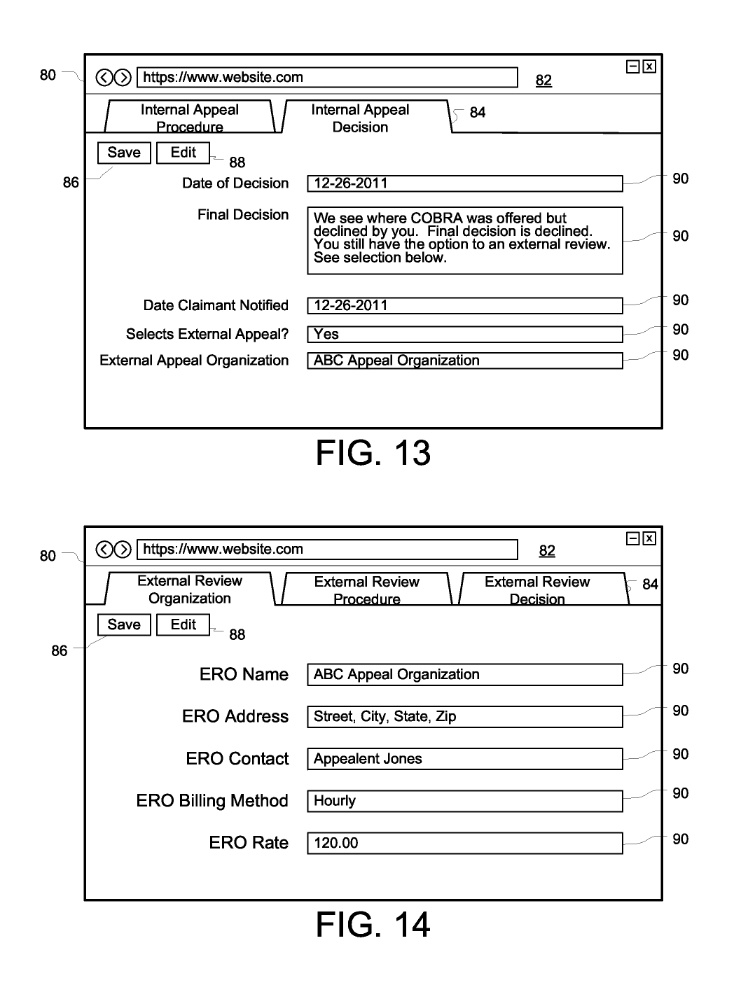

In some embodiments, individual text input blocks 90 and information submitted in such text input blocks 90 in the webpages generated by the server can be configured to only allow certain parties to the appeal to view and/or modify the information in the text input blocks 90. For example, the final decision, shown in FIG. 13, may only be edited by the appeal deciding body, but may be viewed by all parties. Other information, such as the claimant information, shown in FIG. 5, may only be edited by the claimant, but viewed by all parties. Such security and access restrictions may vary based on the nature of the information required for each text input block 90, drop down menu, or other such input mechanism.

Turning to FIG. 6, the system can also receive provider identification data, or provider data. The provider can be the health care provider, such as a doctor, surgeon, etc. As such, in some embodiments, the webpage 80 can present this information via a provider information tab 84. One or more webpages 80 can provide various text input blocks 90 for receiving provider data. The webpage 80 can also provide various prompts that indicate the required data that is to be inserted into the various text input blocks 90. For instance, as shown, the webpage 80 can prompt a user to input the facility name, the provider name, the provider specialty, the provider address, and/or the provider phone. Additionally or alternatively, the webpage 80 can prompt a user to input the provider email or other relevant information about the provider. Examples of such provider data is shown in the illustrated text input blocks.

As further shown in FIG. 6, in some embodiments, the webpage 80 provides a button 94 or other mechanism for a claimant to access and view the insurance plan policy or other insurance plan data. This policy can be useful to the claimant in deciding whether to appeal the claim and/or in supporting his/her claim for coverage. In some embodiments, this information is provided by linking to other information on another server, such as the insurance provider server 42 (shown in FIG. 2).

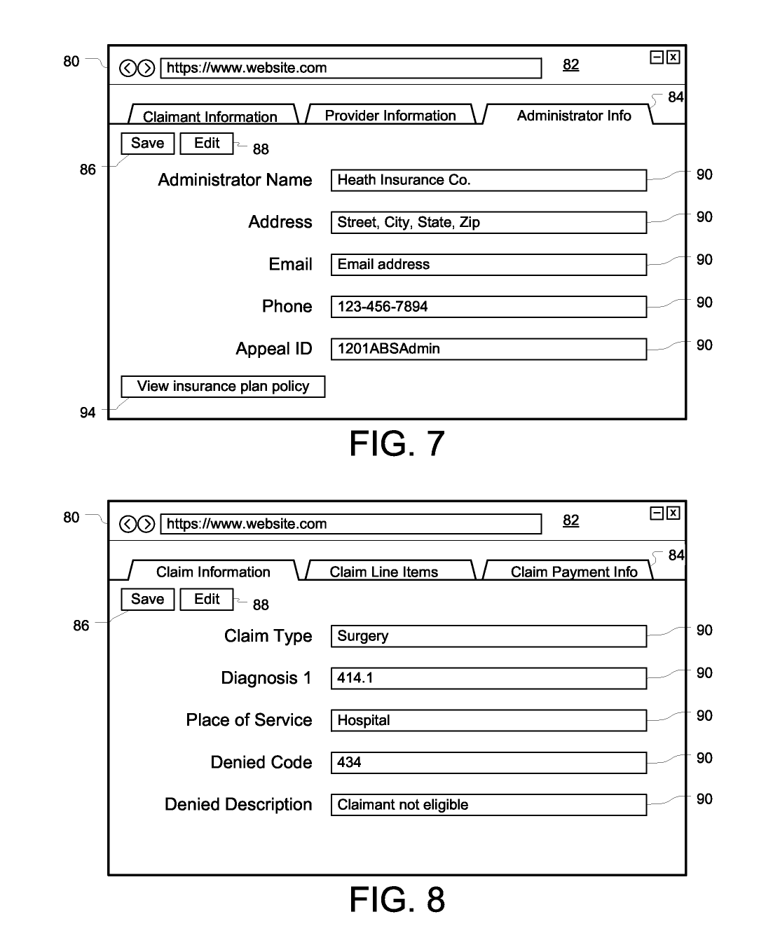

Turning to FIG. 7, the system can also receive administrator identification data, or administrator data. In some embodiments, the webpage 80 can present this information via an administrator information tab 84. One or more webpages 80 can provide various text input blocks 90 for receiving administrator data. The webpage 80 can also provide various prompts that indicate the required data that is to be inserted into the various text input blocks 90. For instance, as shown, the webpage 80 can prompt a user to input the administrator name, the administrator address, email phone, and other such administrator information. Examples of such administrator data is shown in the illustrated text input blocks.

Turning to FIG. 8, the system can also receive claim information as part of the claim data. In some embodiments, the webpage 80 can present this information via a claim information tab 84. Claim information can detail the type of insurance claim for which health care benefits are being sought by the claimant. Non-limiting examples of health insurance claims include claims that prescription drugs or medical procedures be covered by the health care administrator. In some instances, not all heath insurance claims are appealable. In some cases, only claims for coverage of medical care recommended by a physician but denied by the insurance administrator are appealable. As such, embodiments of the system can indentify to the claimant if the claim is appealable, before the claimant initiates the appeal. In some embodiments, one or more webpages 80 can provide various text input blocks 90 for receiving claim information data. The webpage 80 can also provide various prompts that indicate the required data that is to be inserted into the various text input blocks 90. For instance, as shown, the webpage 80 can prompt a user to input the claim type, the one or more diagnoses, the place of service, the denied code provided by the insurance company, the description of the denial, and other such claim information. Examples of such claim information data is shown in the illustrated text input blocks. In some configurations, all parties involved in the appeal can have access to this claim information data.

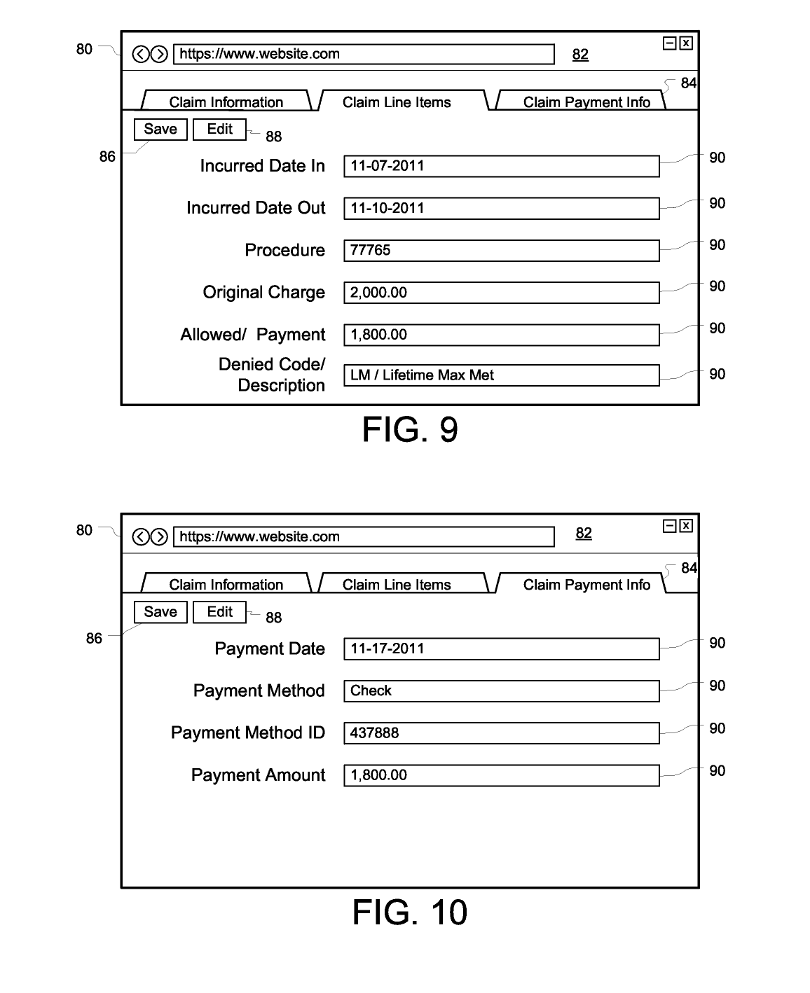

Turning to FIG. 9, depending on the nature of the claim information data received, the system can also receive claim line item information as part of the claim data. In some embodiments, the webpage 80 can present this information via a claim line items information tab 84. In some cases, one or more line items are included in an insurance claim. Also, an insurance administrator can deny coverage of individual line items of a medical bill. Accordingly, the system can receive information about each line item of the claim at issue, as well as each line item of a related procedure or incident. Accordingly, in some embodiments, one or more webpages 80 can provide various text input blocks 90 for receiving claim line item information data. The webpage 80 can also provide various prompts that indicate the required data that is to be inserted into the various text input blocks 90. For instance, as shown, the webpage 80 can prompt a user to input the incurred date in, the incurred date out, the procedure, the original charge, the allowed amount, the payment, the denied code and denied description, the deductable (not shown), co-insurance coverage (not shown), out-of-pocket expenses (not shown), EOB codes (not shown), and other such claim information. Examples of such claim line item information data is shown in the illustrated text input blocks. In some configurations, all parties involved in the appeal can also have access to this claim information data.

In some embodiments, the system receives claim evidence data from the claimant, insurance administrator, or health care provider as part of the claim data. This evidence can include statements, supporting documents, photographs, or other suitable evidence. This information can be uploaded to the server 40 as electronic files. In some instances, a party can submit hard copies of this evidence to the appeals body, which can scan or otherwise digitize this information and make it available for view on the website.

In various embodiments, the claim data can include the information described above, including the claimant data, provider data, administrator data, claim evidence data, and/or claim information (including claim line item data). The claim data can be collected by the system and used to prepare an appeal.

In some configurations, instead of requiring the claimant, administrator, or provider to manually input the aforementioned claim data, the system is configured to automatically read in, upload, or import the claim data from an insurance provider server 42 (shown in FIG. 2) or a health care provider server (not shown). This information can be transmitted over one or more secured or unsecured communication links via one or more networks 38 (shown in FIG. 2). This automatic data input can facilitate the appeals process and reduce the time required for the claimant to input claim data.

After the claim data is received by the appeal server 40, the system can prepare the appeal data, as mentioned above. This can include preparing all necessary documents and forms necessary to file the appeal. In some embodiments, the system also files the appeal data either manually or electronically. For example, referring again to FIG. 2, the appeal server 40 can transmit the appeal data to an insurance provider server 42 that manages appeal docket information for internal appeals. Similarly, in another example, the appeal server 40 can transmit the appeal data to an external review organization server 42 that manages appeal docket information for external appeals of a particular external review organization.

Turning now to FIG. 10, after the appeal is filed, if the appeal deciding body determines to approve of the denied insurance claim it can order the insurance administrator to pay for all or part of the disputed amount. In these instances, the system can provide a webpage containing claim payment data. In some embodiments, the webpage 80 can present this information via a claim payment information tab 84, as shown. Additionally, the webpage 80 can first receive this claim payment data from a party to the appeal proceeding. Accordingly, the webpage 80 can also provide various prompts that indicate the required data that is to be inserted into the various text input blocks 90. For instance, as shown, the webpage 80 can prompt a user (e.g., the insurance administrator) to input the payment data, such as the payment date, the payment method, payment method identity (ID), and payment amount. In some configurations, all parties involved in the appeal can also have access to this claim information data. Accordingly, the claimant can access and view this data via the webpage 80 to receive notification of and/or to track the payment of a claim.

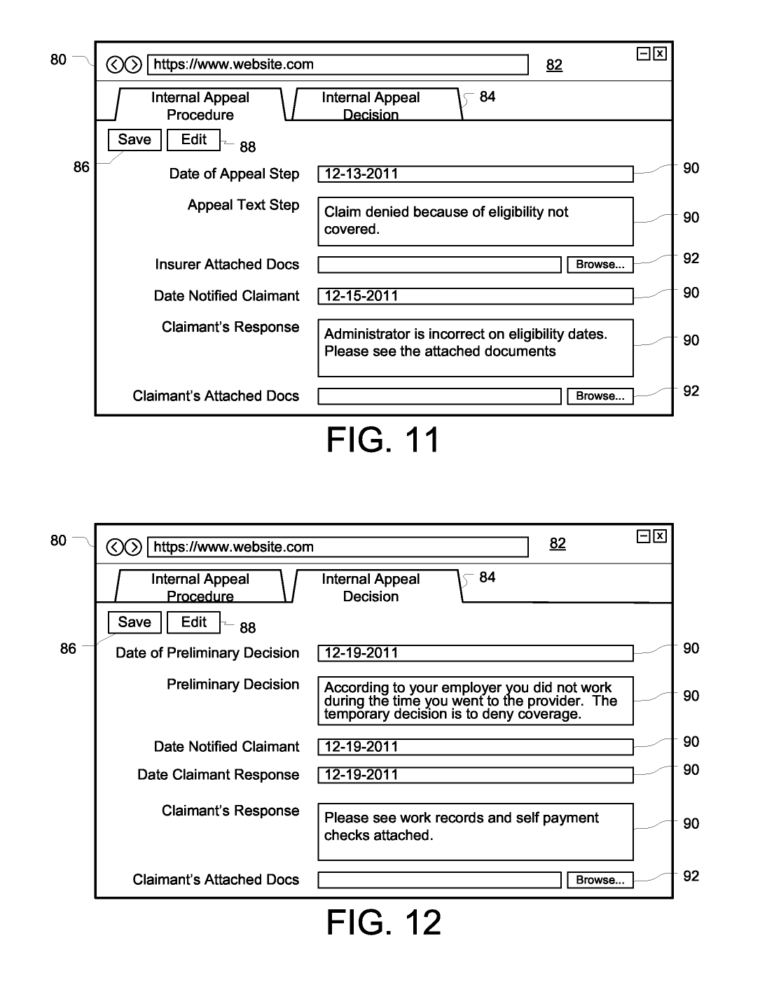

Turning to FIG. 11, the system can provide one or more of the parties of the internal appeal with information about the status of the appeal proceeding. In some embodiments, the webpage 80 can present this information in an internal appeal procedure tab 84, as shown. For example, as shown, the webpage 80 can contain appeal status data, such as information about a step taken in the appeal and a notification of preliminary decision. Additionally, the webpage 80 can receive this information from a party to the appeal in the same manner in which it received the aforementioned claim data. As shown, the webpage 80 can provide information about the date of an appeal step, the appeal text step, and any documents attached to the appeal step that the appeal deciding body reviewed or references. This information can be uploaded to the server 40 via a browse button 92, as is known in the art.

In addition to providing information from the appeal deciding body, the webpage 80 can receive response information and additional evidence data from the claimant and/or the insurance administrator. For example, as shown, the claimant can respond to the illustrated appeal step denying the claim because of eligibility by responding that it was covered and uploading, onto the appeal server 40, the additional evidence data, such as supporting documents, photos, statements, etc. The process of providing status notifications that provide appeal status data relating to the appeal proceeding can be repeated for each appeal step.

Turning to FIG. 12, after the appeal is decided, the system can generate a webpage 80 that contains appeal decision data. In some embodiments, the system provides for a preliminary decision on the appeal, which can be responded to by the claimant and/or the insurance administrator. As shown, the website 80 can contain information submitted by the appeal deciding body, such as the date of a preliminary decision, the preliminary decision, and the date the claimant was notified of this decision. In response, the website 80 can permit the claimant to provide a written response and submit additional evidence data. In some embodiments, no preliminary decision is provided. In other embodiments, multiple preliminary decisions are provided.

Turning to FIG. 13, when the internal appeal is finally decided, the system can generate a webpage 80 that contains the appeal decision data. The appeal decision data can include, as shown, the date of the decision, final decision, and/or any supporting evidence relied upon in forming the final decision (not shown). The webpage 80 can further provide the date the claimant was notified of the decision, and provide the user the option of electing to appeal the decision. Accordingly, in some configurations, the webpage 80 includes an input, such as a text input box 90, a drop down menu, or the like for the claimant to elect to appeal and/or to select an external appeal organization.

Turning to FIG. 14, if the claimant elects to have an external appeal, the system can generate a webpage 80 that provides information about the external appeal and allows the claimant to be informed about and/or select the external review organization (ERO). For example, the claimant can input the name of an ERO in a text input block 90. Alternatively, the claimant may select the ERO from a drop down menu (not shown) that lists available EROs. The website can auto-populate or otherwise receive the ERO contact information, ERO billing method, and ERO billing rate information. This information can assist claimants to select between multiple available EROs.

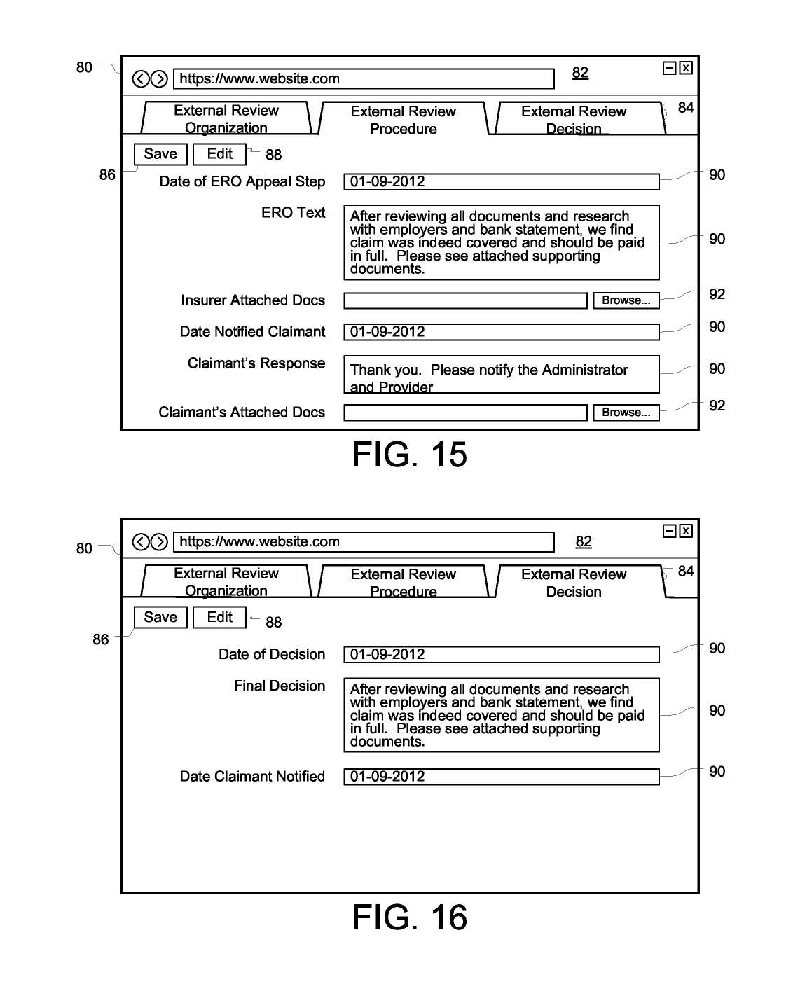

Turning to FIGS. 14 and 15, the system can provide one or more webpages that track the external review procedure and display the external review decision. In some embodiments, these webpages 80 can present this information in an external review procedure tab 84 and an external review decision tab, as shown. These webpages 80 can provide similar information to the parties to those shown in FIGS. 10 through 12. This information and the similar features will now be repeated. It will be recognized that in the preliminary decision, shown in FIG. 15, the insurance administration may be provided the opportunity to respond as well as the claimant (not shown). This can be because the insurance administration is not the appeal body as in the case of the internal appeal. Moreover, as shown in FIG. 16, after the final decision is presented, there may be no opportunity to appeal since the claimant may have exhausted his rights to appeal.

During and following the appeal proceedings, the system, including the appeals server 40 can store data relating to the appeals proceedings. This information can be saved in case it is needed for future reference, audits, or for other purposes. The saved information can include the claim data, the appeal data, the evidence data, and the decision data. The information can be stored, for example, in one or more mass storage devices 26 (shown in FIG. 1) of the appeals server 40 (shown in FIG. 2) or in another server.

Accordingly, from the foregoing it will be seen that the present systems and methods provide a process for appealing an insurance claim through both an internal appeal proceeding and an external appeal proceeding. Since the system controls the appeal process it can ensure that a claimant meets the formal requirements of the appeal process and is notified of pending deadlines and potential pitfalls. These systems and methods can thus benefit insurance organizations and claimants by streamlining and coordinating the appeals process and ensuring that all requirements are met and all parties are notified of their opportunities to state their case.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A computer implemented method for processing an appeal of an insurance claim, the computer implemented method comprising:
receiving, by a server, insurance claim data of a denied insurance claim, the insurance claim data being received via one or more fields of a webpage;
processing the insurance claim data received via the one or more fields to automatically generate appeal data for initiating an appeal proceeding for reviewing the denied insurance claim;
sending the automatically generated appeal data to an appeals body to request that the appeals body initiate the appeal proceeding for reviewing the denied insurance claim; and
generating, by the server, a webpage containing appeal status data relating to the appeal proceeding being conducted by the appeals body.

2. The computer implemented method of claim 1, wherein the appeals body comprises an internal appeals body, the method further comprising:
sending the automatically generated appeal data to an external appeals body to review a decision reached by the internal appeals body regarding the denied insurance claim during the appeal proceeding.

3. The computer implemented method of claim 1, wherein the server is a first server, and further comprising, responsive to preparing appeal data, sending the appeal data, by the first server, to a second server that manages appeal docket information.

4. The computer implemented method of claim 1, wherein the webpage is a first webpage, and further comprising generating, by the server, a second webpage for receiving the insurance claim data.

5. The computer implemented method of claim 1, wherein the server is a first server, and further comprising importing, by the first server, the insurance claim data from a second server of an insurance provider.

6. The computer implemented method of claim 5, wherein automatically generating appeals data comprises converting insurance claim data from a first data format to a second data format.

7. The computer implemented method of claim 1, further comprising receiving the appeals status data from a second server relating to an internal appeal proceeding.

8. The computer implemented method of claim 1, further comprising receiving by the server claimant evidence data; and wherein automatically generating appeals data includes incorporating at least some of the claimant evidence data into the appeal data.

9. The computer implemented method of claim 1, further comprising storing one or more of claim data, claim decision data, and claimant evidence data in a database.

10. The computer implemented method of claim 1, wherein generating a webpage containing appeal status data includes generating a webpage containing decision data when the appeal proceeding decides the denied insurance claim.

11. The computer implemented method of claim 1, wherein generating a webpage containing appeal status data includes generating a webpage containing preliminary decision messages from the appeal body.

12. The computer implemented method of claim 1, wherein generating a webpage containing appeal status data includes generating a webpage containing a preliminary appeal decision of the appeal proceeding.

13. The computer implemented method of claim 12, further comprising receiving by the server, claimant evidence data in response to an issue raised in the preliminary appeal decision.

14. The computer implemented method of claim 1, wherein the claim data includes one or more of insurer information, claimant information, health provider information, reasons for claim denial, denial reason code, or a denial description.

15. The computer implemented method of claim 1, further comprising generating, by the server, a second webpage containing insurance plan data.

16. A method, performed by a computing system, for providing a website that facilitates the submission of an appeal of a denied insurance claim, the method comprising:
displaying fields for receiving insurance claim data of a denied insurance claim, the insurance claim data including claimant information, provider information, administrator information, and claim information;
receiving insurance claim data of a first denied insurance claim via the fields;
processing the insurance claim data received via the fields to automatically generate appeal data that can be submitted to an appeals body to request review of the denied insurance claim;
submitting the appeal data to an appeals body to allow the appeals body to process the appeal data to determine whether the denied insurance claim was correctly denied;
receiving, from the appeals body, decision data representing a determination made by the appeals body regarding the denied insurance claim, the decision data comprising one or more of:
an approval of the denied insurance claim, a reversal of the denied insurance claim, or a modification to the denied insurance claim; and
displaying the decision data.

17. The method of claim 16, wherein the appeals body is an internal appeals body, the method further comprising:
in conjunction with displaying the decision data, displaying one or more fields for receiving input for submitting the appeal data to an external appeals body.

18. The method of claim 16, wherein the input for submitting the appeal data to an external appeals body comprises input that specifies an external appeals body that is to receive the appeal data.

19. The method of claim 16, wherein:
the claimant information comprises one or more of a claimant name, an insured name, claimant contact information, or insured contact information;
the provider information comprises one or more of a facility name, a provider name, a provider specialty, or provider contact information;
the administrator information comprises one or more of an administrator name or administrator contact information; and
the claim information includes one or more of a claim type, a diagnosis, a place of service, a denial code, a description of the reason for the denial, or one or more claim line items.

20. The method of claim 16, further comprising:
prior to receiving the decision data, receiving, from the appeals body, one or more status updates regarding the appeals body's review of the denied insurance claim; and
displaying the one or more status updates.
